(19) United States
(12) Patent Application Publication
(10) Pub. No.: US 2023/0392801 A1
(43) Pub. Date: Dec. 7, 2023

(54) AN EVAPORATIVE AIR COOLER WITH ENHANCED OSCILLATING MECHANISM

(71) Applicant: SYMPHONY LIMITED, Ahmedabad (IN)

(72) Inventor: Achal Anil BAKERI, Ahmedabad (IN)

(21) Appl. No.: 18/032,889

(22) PCT Filed: Oct. 20, 2021
(86) PCT No.: PCT/IN2021/050997

§ 371 Date: Apr. 20, 2023

(30) Foreign Application Priority Data
Oct. 20, 2020 (IN) 202021045779

(51) Int. Cl. F24F 5/00; F24F 13/20

(52) U.S. Cl. CPC F24F 5/0035; F24F 13/20

(57) ABSTRACT

Disclosed is an evaporative air cooler (100) with enhanced oscillating mechanism. The evaporative air cooler (100) includes a bottom assembly (126) including, a tank (116), a gear plate (120) fixed at upper end of the tank (116), a number of balls (124), a primary motor (108) operably connected to a fan blower (110) to rotate fan blades to generate air. The tank (116) acts as a housing for the primary motor (108). The evaporative air cooler (100) also includes a top assembly (102). The top assembly (102) includes a base plate (122) that is attached with a synchronous motor (114). The synchronous motor (114) is operatively connected to a pinion (118) which is operably connected to the gear plate (120). The oscillating mechanism includes synchronous motor (114) configured to oscillate the top assembly (102) while maintaining the bottom assembly (126) in a static position.

### FIELD OF INVENTION

The present embodiment generally relates to evaporative air coolers and more particularly to evaporative air coolers with enhanced oscillating mechanism. Furthermore, the enhanced oscillating mechanism includes a synchronous motor configured to oscillate a top assembly while maintaining a lower assembly in a static position.

### BACKGROUND OF THE INVENTION

Air cooling arrangements are being used globally to maintain a temperature balance within the target surrounding by lowering the temperature of the ambient air. Conventional air coolers include structures such as metal frame body, fan blowers, cloth or stalk film arrangements with a water shower for providing cooling sensation. However, such structures have shortcomings such as rigid and bulky frame structure, low thermal efficiency, and high space occupancy due to larger in size. In fact, evaporation and heat-exchange partly adopts metal frame structure, and heat exchange property sharply descends in case shower water stops. Furthermore, water film forming from top to bottom requires larger internal spacing for moisture film to capture the moisture for longer period so as to provide enhanced cooling. However, wind speed is more inhomogeneous, even cannot form moisture film, reducing wind speed thereby can reduce heat transfer efficiency simultaneously, thereupon increases the energy consumption. Additionally, when the circulated sprinkling water once cools off the showered water moves under higher temperature easily at the heat exchange element surface and that also reduces the heat transfer effect.

In order to enhance the cooling and reduce the energy consumption, evaporative air coolers have been introduced. Such evaporative air coolers have air circulation arrangements such as fan blowers with swing mechanism and movable louvers to direct the flow of the air. However, such arrangements for the evaporative air coolers have their own limitations such has low efficiency due to high energy cost, are noisy due to complex functioning, hazardous and short operational life span. Majorly, the movement of the louvers with respect to the fan blowers are complex in design resulting in low efficiency and noisy when operated.

Therefore, in light of foregoing discussion there is a need to overcome the limitations with housing arrangements for the conventional evaporative air coolers.

### SUMMARY OF INVENTION

In one aspect of the disclosure, an evaporative air cooler with oscillating mechanism, the evaporative air cooler including a top assembly provided with a primary motor operably connected to a fan blower to rotate fan blades and a synchronous motor coupled to a base plate of the top assembly; a bottom assembly having a gear plate provided with a rack wherein a pinion is operably connected with the synchronous motor and is configured to roll on the rack of the gear plate of the bottom assembly to oscillate the top assembly while maintaining the axle of the primary motor in a static position.

In another aspect, the base plate of the top assembly is rotatably coupled to the gear plate of the bottom assembly though a plurality of balls guided on plurality of blind slots provided on the gear plates.

In another aspect, a plurality of teeth of the pinion are in mesh with a plurality of teeth of the rack of the gear plate to enable oscillation of the top assembly.

In another aspect, the rack of the gear plate and the pinion is a straight spur gear.

In another aspect, the synchronous motor is configured to oscillate the top assembly with respect to flow of air from the fan blower synchronously.

In one aspect of the disclosure, a method for operating evaporative air cooler with oscillating mechanism, the method includes steps of initiating a primary motor that is operably connected to a fan blower to rotate fan blades to generate air, oscillating a top assembly by virtue of a synchronous motor operatively connected to a gear plate through a pinion, maintaining the axle of the primary motor in a static position and guiding the air circulation via a number of louvers of the top possible.

In another aspect, the pinion is configured to roll on a rack of the gear plate.

In another aspect, a base plate of the top assembly is rotatably coupled to a gear plate of a bottom assembly though a plurality of balls guided on a plurality of blind slots provided on the gear plate.

In another aspect, the synchronous motor is configured to oscillate the top assembly with respect to flow of air from the fan blower synchronously.

### BRIEF DESCRIPTION OF THE DRAWINGS

Other objects, features, and advantages of the embodiment will be apparent from the following description when read with reference to the accompanying drawings. In the drawings, wherein like reference numerals denote corresponding parts throughout the several views:

FIG. 1A illustrated is an exploded view of the evaporative air cooler (100), according to an embodiment herein;

FIG. 1B illustrated is a block diagram of the evaporative air cooler (100) according to another embodiment herein; and

FIG. 2 illustrated is a flow chart of a method (200) for operating evaporative air cooler (100) with enhanced oscillating mechanism, according to another embodiment herein.

### DETAILED DESCRIPTION OF THE PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Throughout the present disclosure, the term “evaporative air cooler” refers to air blowers implemented with air cooling systems. Such air coolers of the evaporative type are not unusual to pass a stream of warm dry air through a shower of cool water. In this manner, a portion of the water is evaporated by the passage of the warm air circulating through the water shower, the air giving up some of its heat to the water. Quite naturally, heat is transferred during this evaporative process from the air to the cooler water which is then partially vaporized, thus lowering the temperature of the air stream, which can then be directed to an area to be cooled. Furthermore, the evaporated water or water vapour into the area to be cooled by the stream of cooled air, thereby raises the humidity of the area and in effect nullifying, or at least decreasing, the natural cooling which people experience through the evaporation of perspiration from their bodies.

Throughout the present disclosure, the term “louver” refers to “plurality of louvers” arranged. The plurality of louvers so arranged are treated as a louver section and therefore referred herein as “louver”.

Throughout the present disclosure, the term “oscillating mechanism” refers to a swing arrangement that oscillates the top assembly with respect to the base. Furthermore, the oscillating mechanism as used herein includes a pinion(s)and gear plate(s) to provide rotatory motion to the top assembly while maintaining the base at static. Beneficially, the top assembly smoothly oscillates in a predefined arc with respect to the base. In a preferred embodiment, the oscillating mechanism oscillates the louvers in the predefined arc to increase the span of flow of air circulated therefrom. In an instance, the predefined arc encompasses switching of the louver from one extended state to a second extended state. As used herein the extended state refers to a direction of rotation of the top assembly with respect to the base plate while maintaining the diametrical alignment to each other (as discussed herein below in detail).

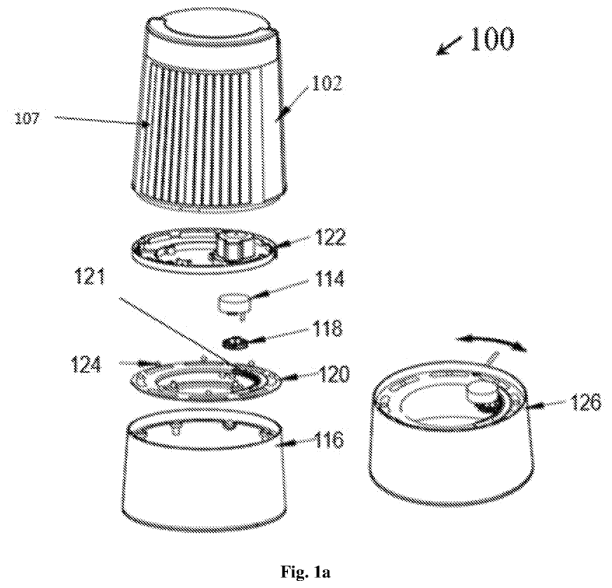

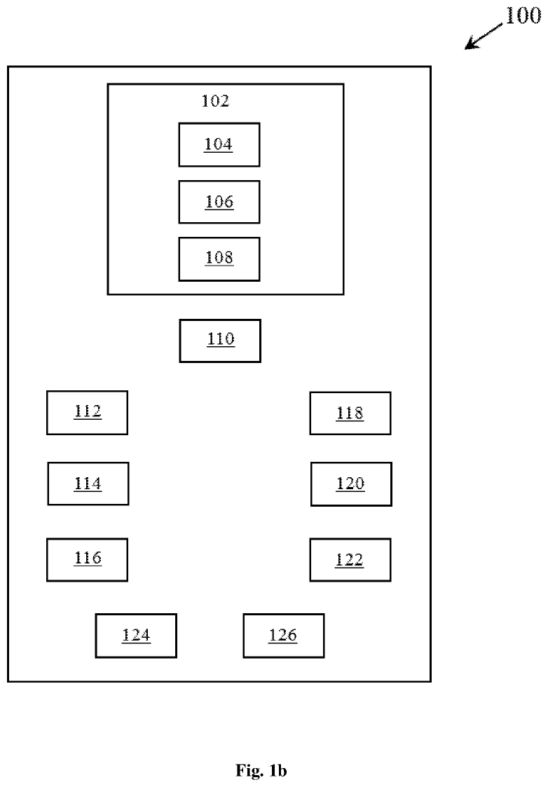

FIGS. 1A and 1B are illustrations of an evaporative air cooler (100) with an oscillating mechanism, according to an embodiment herein. As shown, FIG. 1A is an exploded view of the evaporative air cooler (100). FIG. 1B is a block diagram of the evaporative air cooler (100).

The evaporative air cooler (100) includes a bottom assembly (126) including, a tank (116), a gear plate (120) fixed at upper end of the tank (116), a number of balls (124) (hereinafter referred to as ball). The evaporative air cooler (100) also includes a top assembly (102). The top assembly (102) includes a louver (107), a primary motor (108) operably connected to a fan blower (110) to rotate fan blades to generate air, a base plate (122) that is attached with a synchronous motor (114). The synchronous motor (114) is operatively connected to a pinion (118) which is operably connected to the gear plate (120).

The synchronous motor (114) is operably connected to the tank (116) as described in greater detail herein below. The pinion (118) is connected to output shaft of the synchronous motor (114). The pinion (118) is in mesh with a rack (121) that is provided on the inner side of the gear plate (120). The synchronous motor (114) is configured to rotate the pinion (118). Since the pinion (118) is in mesh with the rack (121) of the gear plate (120). The gear plate (120) being fixed to upper end of the tank (116) thereby the rotation of the pinion (118) is outputted as rolling motion of the pinion (118) on the rack (121) of the gear plate (120). The pinion (118) thus exhibits rolling motion over the rack (121) of the gear plate (120). The pinion (118) is connected to the synchronous motor (114) and the synchronous motor (114) is attached on the base plate (122). The rolling motion of the pinion (118) thus transmitted to the base plate (122) and enable the base plate (122) to turn or rotate. The rotation of the base plate (122) consequently allows oscillation of the top assembly (102) while the bottom assembly (126) remains static.

According to another embodiment, the bottom assembly (126) including a front panel (104), and a back panel (106) forms the body of the evaporative air cooler (100). Furthermore, the bottom assembly (126) may include a flattened or a curved structure such as cuboidal or a cylindrical shape. In an instance, the front panel (104), and the back panel (106) are separately arranged. In such an instance, the front panel may be a curved structure whereas the back panel (106) may be a flat structure. In yet another embodiment, the rack (121) is a curved rack having an arcuate shape.

In yet another embodiment, the primary motor (108) is provided inside the body of the evaporative air cooler (100) to circulate the ambient air. Furthermore, the fan blade of the fan blower (110) generates air pressure inside the body and thereby forms a stream of air to be blown outside. Moreover, the evaporative air cooler (100) also includes the air guide compartment (112) to direct the flow of stream of air. In an embodiment, the air guide compartment (112) further includes the louver (107) arranged in a vertical position or in a horizontal position. The synchronous motor (114) is configured to oscillate the top assembly (102) while maintaining the axle of the primary motor (108) in a static position. The evaporative air cooler (100) includes the synchronous motor (114) that is configured to oscillate the top assembly (102) with respect to flow of air from the fan blower (110) synchronously.

As mentioned herein above, the synchronous motor (114) operably connected to the tank (116) by the gear plate (120) that in turn via a pinion (118), base plate (122) and ball (124), are provided to oscillate the one or more louvers (107) synchronously with the flow of the air stream directed from the fan blower (110).

In yet another embodiment, the gear plate (120) is a ring type gear and the pinion (118) engages in the inside of gear plate (120) for obtaining bigger speed reducing ratio to lower the velocity of rotation of top assembly (102). Furthermore, the pinion (118) rolls over the teeth or slots of the gear plate (120). As shown in FIG. 1A, the rack (121) of the gear plate (120) forms an arc that includes an arc length of one-fourth of the length of the circumference of the base plate (122). Furthermore, the switching of the gear plate (120) from one extended position to other second extended position is performed to enable widespread of air to the surrounding. Moreover, the synchronous motor (114) is configured to switch the base plate (122) from one extended position to the second extended position via the engagement of the pinion (118) with the gear plate (120). In an example, the arc length from one extended position to the second extended position includes an angle range, but not limited to, from 30 degrees to 60 degrees perpendicular to the line of action. The switching of the base plate (122) from one extended position to the second extended position is performed to enable widespread of air to the surrounding.

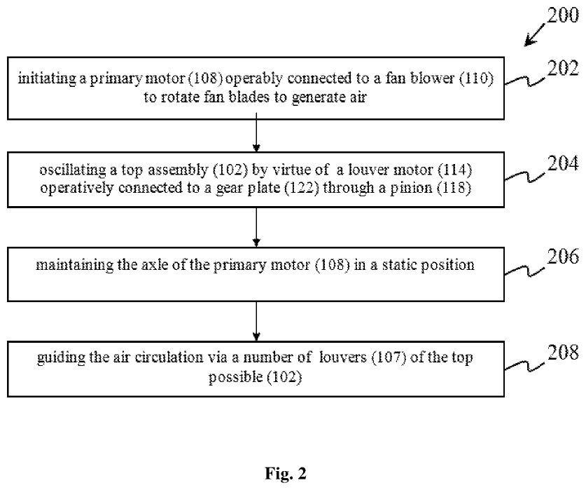

FIG. 2 illustrated is a flow chart of a method (200) for operating evaporative air cooler (100) with enhanced oscillating mechanism, according to another embodiment herein.

At step (202), initiating a primary motor (108) that is operably connected to a fan blower (110) to rotate fan blades to generate air; wherein

At step (204), oscillating a top assembly (102) by virtue of a synchronous motor (114) operatively connected to a gear plate (122) through a pinion (118);

At step (206), maintaining the axle of the primary motor (108) in a static position; and

At step (208), guiding the air circulation via a number of louvers (107) of the top assembly (102).

In an embodiment, a rolling contact between the gear plate (120) and the base plate (122) is provided with the half round blind slots for movement of ball (124).

In an embodiment, the base plate (122) is made up of wear resistant plastic raw material, ball (124) is made up of Mill stainless steel material, gear plate (120) and pinion (118) is made up of wear resistant plastic raw material.

As will be readily apparent to a person skilled in the art, the present invention may easily be produced in other specific forms without departing from its essential composition and properties. The present embodiments should be construed as merely illustrative and non-restrictive and the scope of the present invention being indicated by the claims rather than the foregoing description, and all changes which come within therefore intended to be embraced therein.

1. An evaporative air cooler (100) with oscillating mechanism, the evaporative air cooler (100) comprising:
a top assembly (102) provided with a primary motor (108) operably connected to a fan blower (110) to rotate fan blades and a synchronous motor (114) coupled to a base plate (122) of the top assembly (102); a bottom assembly (126) having a gear plate (120) provided with a rack (121) wherein a pinion (118) is operably connected with the synchronous motor (114) and is configured to roll on the rack (121) of the gear plate (120) of the bottom assembly to oscillate the top assembly (102) while maintaining the axle of the primary motor (108) in a static position.

2. The evaporative air cooler (100) as claimed in claim 1, wherein the base plate (122) of the top assembly (102) is rotatably coupled to the gear plate (120) of the bottom assembly (126) though a plurality of balls (124) guided on plurality of blind slots provided on the gear plates (120).

3. The evaporative air cooler (100) as claimed in claim 1, wherein a plurality of teeth of the pinion (118) are in mesh with a plurality of teeth of the rack (121) of the gear plate (120) to enable oscillation of the top assembly (102).

4. The evaporative air cooler (100) as claimed in claim 1, wherein the rack of the gear plate (120) and the pinion (118) is a straight spur gear.

5. The evaporative air cooler (100) as claimed in claim 1, wherein the synchronous motor (114) is configured to oscillate the top assembly (102) with respect to flow of air from the fan blower (110) synchronously.

6. A method (200) for operating evaporative air cooler (100) with oscillating mechanism, the method (200) comprising:
Initiating (202) a primary motor (108) that is operably connected to a fan blower (110) to rotate fan blades to generate air; wherein
Oscillating (204) a top assembly (102) by virtue of a synchronous motor (114) operatively connected to a gear plate (122) through a pinion (118);
Maintaining (206) the axle of the primary motor (108) in a static position; and Guiding (208) the air circulation via a number of louvers (107) of the top assembly (102).

7. The method (200) as claimed in claim 7, wherein the pinion (118) is configured to roll on a rack (121) of the gear plate (120).

8. The method (200) as claimed in claim 7, wherein a base plate (122) of the top assembly (102) is rotatably coupled to a gear plate (120) of a bottom assembly (126) though a plurality of balls (124) guided on a plurality of blind slots provided on the gear plate (120).

9. The method (200) as claimed in claim 7, wherein the synchronous motor (114) is configured to oscillate the top assembly (102) with respect to flow of air from the fan blower (110) synchronously.
